(19) United States
(12) Patent Application Publication
(10) Pub. No.: US 2016/0037820 A1
(43) Pub. Date: Feb. 11, 2016

(54) MINERAL FORTIFICATION SUBSTANCE FOR CLEAR BEVERAGES

(71) Applicant: Innophos Inc., Cranbury, NJ (US)

(72) Inventors: John Godber, Chicago, IL (US); Amr Shaheed, Howell, NJ (US); Lewis Hendricks, Southampton, PA (US)

(21) Appl. No.: 14/802,476

(22) Filed: Jul. 17, 2015

Related U.S. Application Data
(63) Continuation of application No. 12/611,022, filed on Nov. 2, 2009, now abandoned.
Application No. 12/611,022 is a continuation-in-part of application No. 11/811,199, filed on Jun. 8, 2007, now abandoned.
(60) Provisional application No. 60/812,215, filed on Jun. 9, 2006.

(51) Int. Cl. A23L 2/52; A23L 1/304

(52) U.S. Cl. CPC A23L 2/52; A23L 1/304; A23V 2002/00

(57) ABSTRACT

The present invention relates to compositions comprising minerals which are soluble in water and juice. The compositions of the present invention dissolve in a beverage without any cloudiness or sedimentation. Methods of making said compositions are also provided. Said compositions are also suitable for tableting.

### CROSS REFERENCE TO RELATED APPLICATIONS

The present application is a divisional of U.S. application Ser. No. 12/611,022 filed Nov. 2, 2009, the entire contents of which is hereby incorporated by reference.

### BACKGROUND OF THE INVENTION

The present invention relates to a composition comprising compounds containing minerals that are readily soluble in water, clear beverages and fruit juices. In a water or clear beverage application, the present invention provides a composition that produces beverages without any observable cloudiness or sedimentation. In a fruit juice application, such as juice produced from orange, pineapple, unfiltered apple or apricot, a composition of the present invention can be used to produce a beverage that is free of sedimentation. The process for preparing said composition involves combining one or more mineral portion containing compounds with one or more food grade acids to produce a free flowing, readily soluble solid composition. When used as a mineral supplementation material in beverages, the composition does not significantly alter the flavor, pH or color of the beverage.

Minerals are important to human health. Typically, health care providers classify minerals as essential and trace. Essential minerals include calcium, iron, magnesium, potassium, phosphorus and zinc. Trace minerals include chromium, copper, iodine, manganese, molybdenum and selenium. For example, Calcium is an essential element in the human diet. Calcium plays a structural role as one of the components of bones and teeth. It is also an essential element in several physiological systems, such as blood clotting, cell membrane permeability and muscular contraction, including cardiac contractility. Because calcium is constantly being excreted, and the body cannot synthesize calcium, a human must consume sufficient dietary calcium to provide the body's daily requirement for calcium. The ability of humans to absorb and to use dietary calcium varies considerably and is a strong function of the other components of the diet. For example, if an individual ingests a high protein meal, typically around 15% of the calcium present in the food is absorbed by the body. On the other hand, when the diet is very low in protein, only about 5% of the dietary calcium is absorbed. Other factors in the diet can have similar effects. Phosphate metabolism is closely linked with calcium metabolism, and the concentration of one affects the absorption of the other. If either calcium or phosphate is present in the body in excess, as the body excretes the excess element, the excretion of the other is also increased.

Phosphorus is found in every cell in the body, but the majority of phosphorus is found associated with calcium in the bones and the teeth. Approximately 10% of the phosphorus in the body, in the form of phosphate, is present in combination with proteins, lipids carbohydrates and with nucleic acids in DNA. Another 10% of the phosphorus in the body is widely distributed in a large variety of compounds throughout the body. In the cells of the body, phosphorus contributes to many important chemical reactions. For example, the energy necessary for metabolism is produced when the phosphate bonds of ATP are broken.

Healthy bones require both calcium and phosphate. The mineral portion of bone is composed of a calcium phosphate known as hydroxyapatite. Healthy bone is constantly being reformed through a process of dissolution and recrystallization of the hydroxyapatite. To operate properly, this process requires a constant source of calcium and phosphate.

Iron, magnesium, zinc and potassium also play significant roles in human health. Iron is incorporated in to the haemoglobin molecule and, thus, functions in oxygen transport to the cells making it important to energy production, collagen synthesis and proper immune functioning. Magnesium is essential to maintaining the acid/alkaline balance in the body and in nerve and muscle function, as well as bone growth. Zinc supports healthy immune function and protein synthesis. Potassium is critical to transmission of nerve impulses, muscle contractions and blood pressure maintenance.

It is clear that the ability of food manufacturers to make stable, attractive, low cost products fortified with minerals could contribute to ensuring that the mineral requirements for human nutrition are met. Indeed, food manufacturers desire to fortify their products with minerals. However, adding minerals can alter the taste, appearance and other organoleptic properties of the food product.

### DESCRIPTION OF THE RELATED ART

Mineral fortification of beverages presents special problems because of the cloudiness (turbidity), sedimentation, and the altered taste profiles caused by the addition of poorly soluble, or insoluble, minerals. Those skilled in the art have long been working to solve these problems.

U.S. Pat. No. 6,569,477 (US'477) discloses powders comprised of minerals such as calcium that have been mixed in solution with an acid, completely solubilised at high concentrations, dried and ground. These powders are highly soluble when reconstituted in aqueous solutions. For example, Col. 4 of US '477 discloses, in relevant part, that the powdered mineral salts are prepared as follows: a desired amount of a calcium salt, such as calcium carbonate or calcium hydroxide, is first added to water, preferably warm water at around 70-74 degree F. Other temperatures can be used. The water needs to be at a temperature that will allow for an even distribution of the mineral(s) and any other ingredients that will be added at this point. The mineral is preferably in powder form to speed solubilization. The solution is mixed until all of the mineral powder is wet and evenly distributed within the aqueous solution. Next, the chosen acid is added. Preferably this is done slowly while continuing to mix the solution so that the minerals and any other ingredients are evenly distributed in the aqueous solution. Foaming is monitored. The mixing speed as well as the rate of acid addition can be decreased to prevent foaming. At this step, manufacturing is easier if the solution is not boiling. However, if boiling is required to allow the minerals to react and go into solution, the whole mixture can be brought to a boil after the initial reaction of the acid(s) and mineral(s) has taken place. US'477 also discloses that the acid used combines with the minerals to form a salt, so acids that result in bioavailable mineral salts are preferred. Examples of acids that can be used are lactic acid, acetic acid, citric acid, malic acid, phosphoric acid, ascorbic acid, and/or any food grade acid that will solubilize the mineral or mineral mix or combinations thereof. The amount of acid to add to the minerals is that which will cause the final dry composition to reconstitute in water and become clear, relatively odorless and relatively taste-free. If the flavor of the reconstituted powder is too acidic, then the amount of acid is decreased. If the reconstituted powder is not clear/transparent, then the amount of acid is increased. The amount of acid used is usually about two to three times the weight of the mineral component. This amount of acid used will vary based on the acid(s) being used and the mineral(s) and mineral forms being used.

US '477 further discloses that as the acid is added, an exothermic reaction takes place, raising the temperature of the mixing solution. The temperature can also be raised by application of external heat. The preferred temperature is at least around 130 degree F., such as around 140 degree F. or 150 degree F., preferably around 160 degree F., also preferably around 190 degree F., more preferably around 180 degree F., most preferably around 170 degree F., although temperatures higher than 190 degree F. are also useful. The temperature is chosen that allows the solution to become translucent by the solubilization of all of the minerals and acids. Conversely, the present invention does not require the use of energy intensive, high temperature processing.

When the solubilization is complete, the composition is ready to be dried. Different drying systems require specific conditions. Examples of drying systems include, but are not limited to, freeze drying, spray drying, tray drying, and vacuum drying.

U.S. Pat. No. 6,261,610 discloses that Calcium-Magnesium Lactate-Citrate complexes of the present invention are preferably formed by mixing a suspension of an alkaline calcium source, e.g., calcium hydroxide, calcium oxide or calcium carbonate, with the appropriate quantity of a suspension of an alkaline magnesium source, e.g., magnesium hydroxide, magnesium oxide or magnesium carbonate, and then mixing with the desired amount of a solution of citric and lactic acids. Said alkaline calcium source must be in suspension. Suspensions are heterogeneous fluids containing solid particles that are sufficiently large for sedimentation and will reduce the clarity of the solution.

US 2008/0268102, assigned to Conopco, states: Although the inventors do not wish to be bound by theory it is believed that the addition of a biopolymer to the metastable clear solution stabilizes the dissolved salts of the first and second mineral in that the charged groups of the biopolymer somehow complex charged mineral salts. As a result, these mineral salts are kept in suspension due their association to said biopolymer. Examples of biopolymers that may suitably be used in accordance with the invention include protein and anionic polysaccharides. According to one preferred embodiment the protein is milk protein or soy protein, soy protein being particularly preferred. Conversely, the present invention does not require the presence of a biopolymer to remain in solution, nor is a suspension required.

However, a need still exists for a composition for the mineral supplementation of beverages which is inexpensive and energy efficient to produce, leads to a clear, stable beverage, and a sedimentation free beverage in the case of juices, which does not impact the flavor profile of the beverage and is easy to handle. The present invention solves the problems in the art because the process of the present invention does not require water as in U.S. Pat. No. 6,569,477, U.S. Pat. No. 6,261,610 and US 2008/0268102. Also, U.S. Pat. No. 6,569,477 requires higher temperatures and drying; US 2008/0268102 requires a biopolymer to stay in solution.

### SUMMARY OF THE INVENTION

The present invention relates to a process for producing a composition which may be used to mineral fortify clear beverages, comprising the steps of:

(a) selecting a compound containing a mineral portion wherein the mineral portion of said compound is selected from the group consisting of calcium, zinc, and magnesium and mixtures thereof; and

(b) selecting an edible acid from the group consisting of phosphoric, lactic, malic, citric, tannic, fumaric, and gluconic and mixtures thereof; and

(c) combining said mineral portion containing compound (a) and said edible acid (b) to produce a composition wherein the proportion of said mineral portion containing compound (a) to said edible acid (b) in said composition is such that a 1 wt % solution of said composition has a turbidity of less than 10 NTU and a pH of between about 2.8 to about 3.2.

The present invention further relates to a process for producing a composition which may be used to mineral fortify juices, comprising the steps of:

(a) selecting a compound containing a mineral portion wherein the mineral portion of said compound is selected from the group consisting of calcium, zinc, and magnesium and mixtures thereof; and

(b) selecting an edible acid from the group consisting of phosphoric, lactic, malic, citric, tannic, fumaric, and gluconic and mixtures thereof; and

(c) combining said mineral portion containing compound (a) and said edible acid (b) to produce a composition wherein the proportion of said mineral portion containing compound (a) to said edible acid (b) in said composition is such that a 1 wt % solution of said composition is not susceptible to sedimentation and said composition has a pH of between about 2.8 to about 3.2.

Further, said process produces a free flowing solid.

### DETAILED DESCRIPTION OF THE INVENTION

The present invention relates to a process for producing a composition which may be used to mineral fortify clear beverages, comprising the steps of:

(a) selecting a compound containing a mineral portion wherein the mineral portion of said compound is selected from the group consisting of calcium, zinc, and magnesium and mixtures thereof; and

(b) selecting an edible acid from the group consisting of phosphoric, lactic, malic, citric, tannic, fumaric, and gluconic and mixtures thereof; and

(c) combining said mineral portion containing compound (a) and said edible acid (b) to produce a composition wherein the proportion of said mineral portion containing compound

(a) to said edible acid (b) in said composition is such that a 1 wt % solution of said composition has a turbidity of less than 10 NTU and a pH of between about 2.8 to 3.2.

The present invention further relates to a process for producing a composition which may be used to mineral fortify juices, comprising the steps of:

(a) selecting a compound containing a mineral portion wherein the mineral portion of said compound is selected from the group consisting of calcium, zinc, and magnesium and mixtures thereof; and

(b) selecting an edible acid from the group consisting of phosphoric, lactic, malic, citric, tannic, fumaric, and gluconic and mixtures thereof; and

(c) combining said mineral portion containing compound (a) and said edible acid (b) to produce a composition wherein the proportion of said mineral portion containing compound (a) to said edible acid (b) in said composition is such that a 1 wt % solution of said composition is not susceptible to sedimentation and said composition has a pH of between about 2.8 to about 3.2.

Further, said process produces a free flowing solid.

### Definitions and Usages of Terms

The term “sedimentation” as used herein means the tendency for particles in suspension, or molecules in solution to, settle out of the fluid in which they are entrained, and come to rest against a surface.

The term “turbidity” as used here in means the cloudiness or haziness of a fluid caused by individual particles (or suspended solids) that are generally not discretely visible to the naked eye. Fluid can contain suspended solid matter consisting of particles of many different sizes. While some suspended material will be large enough and heavy enough to settle rapidly to the bottom of the container if a liquid sample is left to stand (the settleable solids), very small particles will settle only very slowly, or not at all, if the sample is regularly agitated or the particles are colloidal. These small solid particles cause the liquid to appear cloudy or turbid.

The term “clear beverage”, as used herein, is understood to include water as well as clear flavored beverages, including, but not limited to teas (herbal and caffeinated), sports drinks, flavored and unflavored sparkling waters, and clear sodas such as Sprite® and 7 UP®.

The term “free flowing solid”, as used herein, means any substance consisting of solid particles which is of, or is capable of being of, a flowing or running consistency.

The term “sachet”, as used herein, means a small disposable bag often used to contain single-use quantities of a product. Said sachet can be plastic, paper or fabric (tightly woven or mesh).

### (a) Mineral Containing Compounds Useful in the Practice of the Present Invention

The mineral containing compounds useful in the practice of the present invention are those compounds having a pH greater than 7 (i.e., a basic pH). The mineral portion of said compound is selected from the group including, but not limited to, calcium, zinc, and magnesium and mixtures thereof. Said mineral containing compounds are dry.

In an embodiment of the invention, useful compounds containing the mineral calcium include, but are not limited to, dicalcium phosphate, tri calcium phosphate, monocalcium phosphate, and mixtures thereof. Said calcium mineral containing compounds are dry.

In an embodiment of the invention, useful compounds containing the mineral zinc include, but are not limited to, Zn(OH)2, ZnHPO4 and mixtures thereof. Said zinc mineral containing compounds are dry.

In an embodiment of the invention, useful compounds containing the mineral magnesium include, but are not limited to, MgCO3, Mg(OH)2, MgHPO4 and mixtures thereof. Said magnesium mineral containing compounds are dry.

In an embodiment of the invention, a compound containing calcium metal such as dicalcium phosphate, a compound containing magnesium metal such as Mg(OH)2 and a compound containing zinc metal such as ZnHPO4 can be formulated into a flowable solid that is readily dissolved in clear liquids or juices for the purpose of mineral supplementation. The clear liquid remains clear, and the juice has no sediment at the bottom of the container.

### (b) Edible Acids Useful in the Practice of the Present Invention

Edible Acids Useful in the Practice of the present invention include, but are not limited to, phosphoric, lactic, malic, citric, tannic, fumaric, and gluconic and mixtures thereof. In an embodiment of the invention, phosphoric, lactic, malic, citric, and gluconic are preferred. In another embodiment, phosphoric and fumaric are more preferred. In a further embodiment, phosphoric acid is preferred.

### Preparing the Composition of the Present Invention

The present invention is prepared by combining the dry mineral portion containing compound with an edible acid until a free flowing solid forms. A 1.0 weight % solution of said free flowing solid has a turbidity of less than 10 NTU and a pH of between about 2.8 to 3.2 in a clear beverage application. In a juice application, there is no sedimentation at the bottom of the container and the pH of 2.8 to about 3.2 is maintained. The amount of the dry mineral portion containing compound and the amount of edible acid required to produce the free flowing solid can be readily determined by one skilled in the art having access to molecular weight, valence, solubility and pKA data. The key to the present invention is that it does not require a first addition of water as in U.S. Pat. No. 6,569,477 or the formation of a suspension as in U.S. Pat. No. 6,261,610 and US 2008/0268102. The desired dry mineral portion containing compound(s) and the food grade acid(s) are simply combined using mixing methods and equipment known to those skilled in the art, reducing processing effort.

In a preferred embodiment of the invention, useful compounds containing the mineral calcium include, but are not limited to, dicalcium phosphate or tricalcium phosphate. For example, said dicalcium phosphate or tricalcium phosphate is mixed with an edible acid for a sufficient period of time to allow the materials to react. The calcium phosphates may be in a hydrated or anhydrous form. Alternatively, combinations of monocalcium, dicalcium and/or tricalcium phosphate may be mixed with the edible acid for a sufficient time to allow the materials to react.

In one embodiment of the invention, dicalcium phosphate is combined with phosphoric acid to produce the composition. In a preferred embodiment, anhydrous dicalcium phosphate is provided and phosphoric acid is added to the anhydrous dicalcium phosphate over a period of time while mixing.

In a further embodiment, 85% phosphoric acid is added to the dicalcium phosphate. The materials may be mixed using conventional mixing equipment. The 85% phosphoric acid may be added to the dicalcium phosphate at an approximately constant rate over a sufficient period of time to allow complete mixing, typically, between about 30 minutes and 2 hours. The materials may be combined at ambient temperatures, although the process will produce heat and may cause the temperature of the combined materials to rise.

In another embodiment of the invention, hydrated dicalcium phosphate is combined with phosphoric acid to produce the composition. In a preferred embodiment, dicalcium phosphate dihydrate (CaHPO₄—2H₂O) is provided and phosphoric acid is added to the dicalcium phosphate dihydrate over a period of time while mixing. For example, 85% phosphoric acid is added to the dicalcium phosphate dihydrate. The materials may be mixed using conventional mixing equipment. The 85% phosphoric acid may be added to the dicalcium phosphate dihydrate at an approximately constant rate over a sufficient period of time to allow complete mixing, preferably between about 30 minutes and 2 hours. The materials may be combined at ambient temperatures, although the process will produce heat and may cause the temperature of the combined materials to rise.

In another embodiment of the invention, tricalcium phosphate is combined with phosphoric acid to produce the composition. In this embodiment, tricalcium phosphate is provided and phosphoric acid is added to the tricalcium phosphate over a period of time while mixing. In an embodiment, 85% phosphoric acid is added to the tricalcium phosphate. The materials may be mixed using conventional mixing equipment. The 85% phosphoric acid may be added to the tricalcium phosphate at an approximately constant rate over a sufficient period of time to allow complete mixing, preferably between about 30 minutes and 2 hours. The materials may be combined at ambient temperatures, although the process will produce heat and cause the temperature of the combined materials to rise.

When the phosphoric acid added to the dicalcium phosphate or tricalcium phosphate is less than 85% concentration, it may be necessary to add a drying step to the process to obtain solid material that flows well. In this case, the final product is preferably dried so that the weight loss at 100° C. is less than 1%.

In yet another embodiment of the invention, a mixture of dicalcium phosphate and tricalcium phosphate is combined with phosphoric acid to produce the composition. In a preferred embodiment, a blend of anhydrous dicalcium phosphate and tricalcium phosphate is provided and phosphoric acid is added to the dicalcium phosphate/tricalcium phosphate blend over a period of time while mixing. The dicalcium phosphate and tricalcium phosphate may be provided in any proportion of the two phosphates in the blend. In a preferred embodiment, 85% phosphoric acid is added to the dicalcium phosphate/tricalcium phosphate blend. The phosphoric acid and the dicalcium phosphate/tricalcium phosphate blend may be mixed using conventional mixing equipment. The 85% phosphoric acid may be added to the dicalcium phosphate/tricalcium phosphate blend at an approximately constant rate over a sufficient period of time to allow complete mixing, preferably between about 30 minutes and 2 hours. The materials may be combined at ambient temperatures, although the process will produce heat and cause the temperature of the combined materials to rise.

In still another embodiment of the invention, a blend of ZnHPO4 and MgHPO4 are combined with lactic acid to produce the free flowing solid composition of the present invention. For example, a blend of ZnHPO4 and MgHPO4 is provided and lactic acid is added to the blend of ZnHPO4 and MgHPO4 over a period of time while mixing. Conventional mixing equipment known to those skilled in the art is used. The lactic acid is added at a constant rate over a sufficient period of time to allow complete mixing, preferably between about 30 minutes and 2 hours. Mixing may occur at ambient temperatures, although the process will produce heat and cause the temperature of the combined materials to rise.

In an embodiment of the invention, ZnHPO4 and Mg(OH)2 are combined with a fumaric/phosphoric acid blend. Conventional mixing equipment, known to those skilled in the art, is used to combine the ZnHPO4, the Mg(OH)2, and the acid blend to achieve a flowable powder.

In a further embodiment of the invention, ZnHPO4, dicalcium phosphate, and Mg(OH)2 are combined with a fumaric acid/phosphoric acid/citric acid blend. Conventional mixing equipment, known to those skilled in the art, is used to combine the ZnHPO4, dicalcium phosphate, and Mg(OH)2 with the acid blend to achieve a flowable powder.

It should be noted that the invention is not limited to a process whereby an edible acid is added to a mineral containing compound. In all of the embodiments of the invention described herein, the process can be performed by first providing an edible acid and then adding any mineral containing compound or mixtures thereof to said edible acid and mixing.

Although the product made by the process described above is a free flowing solid, the flowability of the material can be improved if desired by mixing the final composition with tricalcium phosphate as a final step in the process. For example, dicalcium phosphate and phosphoric acid can be combined as described above to produce the composition of the invention. After the composition has been produced, tricalcium phosphate can be mixed with the composition as a flow aid. The tricalcium phosphate can be added in any amount required to give the final product the desired flow characteristics. In a preferred embodiment, the composition produced by the process of the present invention is mixed with tricalcium phosphate in the proportion of 95/5 weight to weight.

As discussed above, the material produced by the methods of the present invention can be dissolved in water or clear beverages to provide an essentially clear solution. When said material is dissolved in juices, there is no sedimentation. Evaluating beverage clarity is subjective. The appearance of a beverage is dependent on the volume through which light passes before entering the eye, the background against which the sample is viewed, and the concentration of the material in water. Also, while the human eye can state whether or not one sample next to another is cloudier or more turbid than its neighbour, comparing samples is fraught with difficulty. Quantatative measurements can reduce the subjective nature of the evaluation. A quantitative method of measuring turbidity relies on the fact that the appearance of turbidity is due to the amount of light which is scattered by suspended particles. Measurements made with a turbidity meter measures the amount of scattered light, by measuring the amount of light at a detector which is placed at an angle (90 degrees) to the incident beam passing through the sample. The apparatus can be calibrated with purchased standards to allow measurements which are accurate and precise. The calibration standards allow one to report turbidity in Nephelometric Turbidity Units (NTU). The material produced by the process of the present invention can be dissolved in water to produce a 1 weight % solution with a turbidity of less than 10 NTU. The pH of the 1 weight % solution is preferably between about 2.8 and about 3.2.

The following non limiting embodiments illustrate the practice of the present invention.

### EXAMPLE 1

In a Hobart mixer, 200 g of dicalcium phosphate anhydrous is provided at a starting temperature of 20° C. While mixing, 200 g of 85% phosphoric acid at 20° C. was added over a period of one hour. After all of the phosphoric acid was added, the materials were mixed for a further 30 minutes. The product remained a free flowing solid. Some heat was released during the reaction which raised the temperature of the final product to about 40° C. X-ray diffraction on the powder showed the material to contain MCP-1 (mono-calcium phosphate monohydrate) as the only crystalline compound. When this material was added to water it dissolved completely without any cloudiness and a turbidity of less than 5 NTU.

### EXAMPLE 2

In a Hobart mixer, 160 g of tricalcium phosphate (TCP) is provided at a starting temperature of 20° C. While mixing, 240 g of 85% phosphoric acid at 20° C. was added over a period of one hour. After all of the phosphoric acid was added, the materials were mixed for a further 30 minutes. The product remained a free flowing solid. Some heat was released during the reaction which raised the temperature to about 50° C. X-ray diffraction on the powder showed the material to contain MCP-1 as the only crystalline compound. When this material was added to water it dissolved completely without any cloudiness and a turbidity of less than 5 NTU.

The composition produced by the process of the present invention may be used to mineral fortify beverages, in particular clear beverages and juices. Because the composition is readily soluble, beverages can be mineral fortified to any desired level by adding the composition at a level to achieve the desired mineral concentration in the beverage.

In yet another embodiment of the invention, the dry, free flowing composition prepared by the blending of the mineral portion containing compounds and the edible acids can be compressed into tablets. For example, the desired mineral portion containing compounds and the desired acids are blended, and a dry, free flowing composition is formed. Said dry, free flowing composition can be compressed into tablets. Active ingredients may be blended with the dry free flowing composition of the present invention prior to compressing into tablets. Active ingredients include, but are not limited to, acebutolol, acetylcysteine, acetylsalicylic acid, aciclovir, alprazolam, alfacalcidol, allantoin, allopurinol, ambroxol, amikacin, amiloride, aminoacetic acid, amiodarone, amitriptyline, amlodipine, amoxicillin, ampicillin, ascorbic acid, aspartame, astemizole, atenolol, beclomethasone, benserazide, benzalkonium hydrochloride, benzocaine, benzoic acid, betamethasone, bezafibrate, biotin, biperiden, bisoprolol, bromazepam, bromhexine, bromocriptine, budesonide, bufexamac, buflomedil, buspirone, caffeine, camphor, captopril, carbamazepine, carbidopa, carboplatin, cefachlor, cefalexin, cefadroxil, cefazoline, cefixime, cefotaxime, ceftazidime, ceftriaxone, cefuroxime, selegiline, chloramphenicol, chlorhexidine, chlorpheniramine, chlortalidone, choline, cyclosporin, cilastatin, cimetidine, ciprofloxacin, cisapride, cisplatin, clarithromycin, clavulanic acid, clomipramine, clonazepam, clonidine, clotrimazole, codeine, cholestyramine, cromoglycic acid, cyanocobalamin, cyproterone, desogestrel, dexamethasone, dexpanthenol, dextromethorphan, dextropropoxiphene, diazepam, diclofenac, digoxin, dihydrocodeine, dihydroergotamine, dihydroergotoxin, diltiazem, diphenhydramine, dipyridamole, dipyrone, disopyramide, domperidone, dopamine, doxycycline, enalapril, ephedrine, epinephrine, ergocalciferol, ergotamine, erythromycin, estradiol, ethinylestradiol, etoposide, Eucalyptus globulus, famotidine, felodipine, fenofibrate, fenoterol, fentanyl, flavin mononucleotide, fluconazole, flunarizine, fluorouracil, fluoxetine, flurbiprofen, furosemide, gallopamil, gemfibrozil, gentamicin, Gingko biloba, glibenclamide, glipizide, clozapine, Glycyrrhiza glabra, griseofulvin, guaifenesin, haloperidol, heparin, hyaluronic acid, hydrochlorothiazide, hydrocodone, hydrocortisone, hydromorphone, ipratropium hydroxide, ibuprofen, imipenem, indomethacin, iohexol, iopamidol, isosorbide dinitrate, isosorbide mononitrate, isotretinoin, ketotifen, ketoconazole, ketoprofen, ketorolac, labetalol, lactulose, lecithin, levocarnitine, levodopa, levoglutamide, levonorgestrel, levothyroxine, lidocaine, lipase, imipramine, lisinopril, loperamide, lorazepam, lovastatin, medroxyprogesterone, menthol, methotrexate, methyldopa, methylprednisolone, metoclopramide, metoprolol, miconazole, midazolam, minocycline, minoxidil, misoprostol, morphine, multivitamin mixtures or combinations and mineral salts, N-methylephedrine, naftidrofuryl, naproxen, neomycin, nicardipine, nicergoline, nicotinamide, nicotine, nicotinic acid, nifedipine, nimodipine, nitrazepam, nitrendipine, nizatidine, norethisterone, norfloxacin, norgestrel, nortriptyline, nystatin, ofloxacin, omeprazole, ondansetron, pancreatin, panthenol, pantothenic acid, paracetamol, penicillin G, penicillin V, phenobarbital, pentoxifylline, phenoxymethylpenicillin, phenylephrine, phenylpropanolamine, phenytoin, piroxicam, polymyxin B, povidone-iodine, pravastatin, prazepam, prazosin, prednisolone, prednisone, bromocriptine, propafenone, propranolol, proxyphylline, pseudoephedrine, pyridoxine, quinidine, ramipril, ranitidine, reserpine, retinol, riboflavin, rifampicin, rutoside, saccharin, salbutamol, calcitonin, salicylic acid, simvastatin, somatropin, sotalol, spironolactone, sucralfate, sulbactam, sulfamethoxazole, sulfasalazine, sulpiride, tamoxifen, tegafur, teprenone, terazosin, terbutaline, terfenadine, tetracycline, theophylline, thiamine, ticlopidine, timolol, tranexamic acid, tretinoin, triamcinolone acetonide, triamterene, trimethoprim, troxerutin, uracil, valproic acid, vancomycin, verapamil, vitamin E, folic acid, and zidovudine.

Also, excipients including, but not limited to, disintegrants, binders, fillers, and lubricants may be added to the dry free flowing composition of the present invention prior to compressing into tablets. Examples of disintegrants include agar-agar, algins, calcium carbonate, carboxymethylcellulose, cellulose, clays, colloid silicon dioxide, croscarmellose sodium, crospovidone, gums, magnesium aluminium silicate, methylcellulose, polacrilin potassium, sodium alginate, low substituted hydroxypropylcellulose, and cross-linked polyvinylpyrrolidone hydroxypropylcellulose, sodium starch glycolate, and starch. Examples of binders include microcrystalline cellulose, hydroxymethyl cellulose, hydroxypropylcellulose, and polyvinylpyrrolidone. Examples of fillers include calcium carbonate, calcium phosphate, dibasic calcium phosphate, tribasic calcium sulfate, calcium carboxymethylcellulose, cellulose, dextrin derivatives, dextrin, dextrose, fructose, lactitol, lactose, magnesium carbonate, magnesium oxide, maltitol, maltodextrins, maltose, sorbitol, starch, sucrose, sugar, and xylitol. Examples of lubricants include agar, calcium stearate, ethyl oleate, ethyl laureate, glycerin, glyceryl palmitostearate, hydrogenated vegetable oil, magnesium oxide, magnesium stearate, mannitol, poloxamer, glycols, sodium benzoate, sodium lauryl sulfate, sodium stearyl, sorbitol, stearic acid, talc, and zinc stearate.

In yet another embodiment of the present invention, the composition of the present invention can be apportioned into sachets for single use applications. In other words, a single serving of the composition of the present invention can be used to fill sachets and the consumer can pour said composition into bottled water, a clear beverage such as green tea, or a juice, thereby mineral fortifying the liquid they are consuming.

We claim:

1. A process for producing a composition which may be used to mineral fortify clear beverages, comprising the steps of:
(a) providing a compound containing a mineral portion wherein the mineral portion of said compound is selected from the group consisting of calcium, zinc, and magnesium and mixtures thereof; and
(b) providing a phosphoric acid as an edible acid; and
(c) combining at a constant rate over a period of about 30 minutes to 2 hours said mineral portion containing compound (a). and said edible acid (b). at ambient temperatures to produce a free flowing solid composition which comprises MCP-1 (mono-calcium phosphate monohydrate); and
(d) adding water to the composition wherein the proportion of said mineral portion containing compound (a) to said edible acid (b) in said composition is such that a 1 wt % solution of said water added composition has a turbidity of less than 10 NTU and a pH of between about 2.8 to about 3.2.

2. The process of claim 1, wherein the phosphoric acid is 85% phosphoric acid.

3. A process for producing a composition which may be used to mineral fortify juices, comprising the steps of:
(a) providing a compound containing a mineral portion wherein the mineral portion of said compound is selected from the group consisting of calcium, zinc, and magnesium and mixtures thereof; and
(b) providing a phosphoric acid as an edible acid; and
(c) combining at a constant rate over a period of about 30 minutes to 2 hours said mineral portion containing compound (a). and said edible acid (b). at ambient temperatures to produce a free flowing solid composition which comprises MCP-1 (mono-calcium phosphate monohydrate); and
(d) adding water to the composition wherein the proportion of said mineral portion containing compound (a) to said edible acid (b) in said composition is such that a 1 wt % solution of said water added composition has a turbidity of less than 10 NTU and a pH of between about 2.8 to about 3.2.

4. The process of claim 3, wherein the phosphoric acid is 85% phosphoric acid.

5. A process for producing a single serving of a composition for mineral fortifying water, a clear beverage or a juice comprising the steps of:
(a) providing a compound containing a mineral portion wherein the mineral portion of said compound is selected from the group consisting of calcium, zinc, and magnesium and mixtures thereof; and
(b) providing a phosphoric acid as an edible acid; and
(c) combining at a constant rate over a period of about 30 minutes to 2 hours said mineral portion containing compound (a). and said edible acid (b). at ambient temperatures to produce a free flowing solid composition which comprises MCP-1 (mono-calcium phosphate monohydrate).

6. The process of claim 5, wherein the phosphoric acid is 85% phosphoric acid.

7. The process of claim 5 or 6, wherein the proportion of said mineral portion containing compound (a) to said edible acid (b) in said dry, free flowing composition is such that said dry free flowing composition can be poured into a single serving sachet.

8. The process of claim 5 or 6, wherein the proportion of said mineral portion containing compound (a) to said edible acid (b) in said dry, free flowing composition is such that said dry free flowing composition can be compressed into tablets for single servings.
